(19) United States
(12) Patent Application Publication
(10) Pub. No.: US 2026/0329009 A1
(43) Pub. Date: Oct. 22, 2026

(54) INTERCONNECT MODULE WITH WAVELENGTH DIVISION MULTIPLEXING/DEMULTIPLEXING CAPABILITY

(71) Applicant: ULTRA COMMUNICATIONS, INC., Vista, CA (US)

(72) Inventors: Joseph F. AHADIAN, SAN MARCOS, CA (US); Sandra SKENDZIC, VISTA, CA (US); Charles B. KUZNIA, ENCINITAS, CA (US); Brad R. BETTMAN, MOUNTAIN VIEW, CA (US); Georgios PANOTOPOULOS, OAKLAND, CA (US); Ye CHEN, SAN JOSE, CA (US)

(21) Appl. No.: 19/131,400

(22) PCT Filed: Dec. 14, 2023
(86) PCT No.: PCT/US2023/084099

§ 371 Date: May 20, 2025

Related U.S. Application Data
(60) Provisional application No. 63/387,779, filed on Dec. 16, 2022.

(51) Int. Cl. G02B 6/293; G02B 6/42; H04B 10/071; H04J 14/02

(52) U.S. Cl. CPC G02B 6/29367; G02B 6/2938; G02B 6/4215; H04B 10/071; H04J 14/02

(57) ABSTRACT

An optical interconnect module operating on a plurality of wavelengths is described. The optical interconnect module may be a wavelength multiplexed transmitter, a wavelength demultiplexed receiver, or a transceiver with both wavelength multiplexing and demultiplexing capabilities. The optical interconnect module is composed of a plurality of components having matched thermal expansion coefficient values. The optical interconnect module has an operating temperature range of approximately −55 C to 95 C and a storage temperature range of approximately −55 C to +125 C. The optical interconnect module may be configured to operate on the short wavelength division multiplexing (SWDM) standard. In some embodiments, an optical time domain reflectometer may be integrated with the optical interconnect module.

### CROSS-REFERENCE TO RELATED APPLICATIONS

The present application claims priority to U.S. Provisional Patent Application No. 63/387,779 filed on Dec. 16, 2022, the content of which is incorporated herein by reference in its entirety.

### GOVERNMENT SUPPORT

This invention was made with government support under grant N68335-21-G-0027 and N68335-22-F-0007 awarded by the United States Navy. The United States government has certain rights in the invention.

### FIELD

The present disclosure relates to a wavelength division multiplexed/demultiplexed (WDM) interconnect module and assembly methods for the module.

### BACKGROUND

Fiber optics (a term synonymous with optical fibers) offers high data rate and electromagnetic interference immunity for high-speed data communications. While being utilized for long distance links, fiber optics is now becoming prevalent in short distance applications, for example within data centers, aircraft systems, and ship-board systems. These systems would benefit from incorporation of an optical time domain reflectometer (OTDR) with high resolution to determine the precise location of fiber faults, breaks, discontinuities, or configuration changes.

Interconnect modules, such as optical transmitters, optical receivers, and optical transceivers, are widely used in high-speed data transmission and reception using fiber optics as part of an optical data communication system. An optical transceiver supports bidirectional optical communication, that is it can both transmit and receive optical signals. An optical transmitter supports unidirectional optical communication, that is it can only transmit optical signals. An optical receiver also supports unidirectional optical communication, that is it can only receive optical signals. A relatively new technology, short wavelength division multiplexing (SWDM), allows a boost in transmission (and therefore reception) capacity by simultaneously transmitting optical signals at four different wavelengths over a single multimode optical fiber (MMF). A typical implementation of an optical transceiver for use in a SWDM optical interconnect module includes four separate channels centered at respective wavelengths of 850 nm, 880 nm, 910 nm and 940 nm, each channel being enabled by a low-cost, vertical-cavity surface emitting laser (VCSEL). The optical transceiver typically has a transmit side with four VCSELs generating optical signals, one VCSEL for each channel, and a receive side with four photodetectors, each detecting optical signals being transmitted in one of the four channels. Often one optical fiber carries the transmit optical signals and a separate optical fiber carries the receive optical channels although in some cases, the transmit and receive signals may be combined and propagate through a single optical fiber.

At least some of the applications of SWDM, such as aircraft or drone systems, require operation over a large temperature range and in a demanding shock and vibration environment. As such a wavelength division multiplexing/demultiplexing optical interconnect module, which may be referred to as a WDM interconnect module, needs to be rugged, operate in dirty environments, and operate over a wide temperature range. This is the subject of the teachings according to the present disclosure.

### SUMMARY

One aspect of the present disclosure includes a wavelength division multiplexed interconnect module for optical data communication. The wavelength division multiplexed interconnect module includes a multiplexing/demultiplexing subassembly and a light emitter assembly or a light detector assembly. The multiplexing/demultiplexing subassembly may include a multiplexing/demultiplexing block having a top surface and an opposed bottom surface, the top surface having an upper recessed region surrounded by a top flat surface and the bottom surface having a lower recessed region surrounded by a bottom flat surface. A plurality of relay reflectors, an input/output reflector, and a coupling lens may be formed on the top surface of the upper recessed region and a filter array may be situated in the lower recessed region and mounted to a top surface of the lower recessed region.

Another aspect of the present disclosure includes an optical transmitter for optical data communication based on a plurality of wavelengths. The optical transmitter includes a multiplexing subassembly and a light emitter assembly having a plurality of light emitters. The multiplexing subassembly may include a multiplexing block having a top surface and an opposed bottom surface, the top surface having an upper recessed region surrounded by a top flat surface and the bottom surface having a lower recessed region surrounded by a bottom flat surface.

Yet another aspect of the present disclosure includes an optical receiver for optical data communication based on a plurality of wavelengths. The optical receiver includes a demultiplexing subassembly and a light detector assembly having a plurality of photodetectors. The demultiplexing subassembly may include a demultiplexing block having a top surface and an opposed bottom surface, the top surface having an upper recessed region surrounded by a top flat surface and the bottom surface having a lower recessed region surrounded by a bottom flat surface.

Yet another aspect of the present disclosure includes an optical transceiver for optical data communication. The optical transceiver includes a multiplexing/demultiplexing subassembly, a light emitter assembly, and a light detector assembly. The multiplexing/demultiplexing subassembly may include a multiplexing/demultiplexing block and a filter array. The multiplexing/demultiplexing block may have a top surface and an opposed bottom surface, the top surface having an upper recessed region surrounded by a top flat surface and the bottom surface having a lower recessed region surrounded by a bottom flat surface.

Yet another aspect of the present disclosure includes an optical communication node including a wavelength division multiplexed interconnect module and an optical connector that terminates at least one optical fiber. The optical communication node may further include a sealing gasket situated between the wavelength division multiplexed interconnect module and the optical connector that isolates an optical path from the surrounding environment. The optical communication node may be configured to operate over a temperature range of approximately −55 C to +95 C.

Yet another aspect of the present disclosure includes a method of forming a multiplexing/demultiplexing subassembly. The method includes molding a multiplexing/demultiplexing block and mounting a filter array to the multiplexing/demultiplexing block. The multiplexing/demultiplexing block may have an upper recessed region and a lower recessed region and the filter array may be mounted in the lower recessed region.

Yet another aspect of the present disclosure includes s wavelength division multiplexed interconnect module having parallel multiplexed optical transmit channels or parallel multiplexed optical receive channels. The parallel channels may be offset from each other in a transverse direction.

Yet another aspect of the present disclosure includes a lens array comprising a transparent rectangular parallelepiped having a top surface and an opposed bottom surface. A recessed region is situated in either the top surface or the bottom surface and the recessed region is surrounded by a flat portion of the top or bottom surface. A plurality of lenses is situated in the recessed region such that no part of any lens extends past the top surface or bottom surface. The lens array is configured to be part of a wavelength division multiplexed interconnect module which operates on a plurality of wavelength channels.

Further aspects of the disclosure are shown in the specification, drawings and claims of the present application.

### BRIEF DESCRIPTION OF DRAWINGS

FIG. 1A shows a top perspective exploded view of a WDM interconnect module with wavelength division multiplexing/demultiplexing capability according to an embodiment of the present disclosure.

FIG. 1B shows a bottom perspective view of the WDM interconnect module of FIG. 1A with exposed electrical and electro-optic elements according to an embodiment of the present disclosure.

FIG. 1C shows a top perspective view of the WDM interconnect module of FIG. 1A in an assembled state mated to an optical connector according to an embodiment of the present disclosure.

FIG. 2 shows details of optical paths in a WDM interconnect module configured as an optical transmitter according to an embodiment of the present disclosure.

FIG. 3 shows a top perspective view of a MUX/DEMUX block according to an embodiment of the present disclosure.

FIG. 4 shows a bottom perspective view of a MUX/DEMUX block according to an embodiment of the present disclosure.

FIG. 5 shows a bottom perspective view of a MUX/DEMUX subassembly according to an embodiment of the present disclosure.

FIG. 6 shows a top perspective view of a lens array according to an embodiment of the present disclosure.

Like reference numbers and designations in the various drawings indicate like elements.

### DETAILED DESCRIPTION

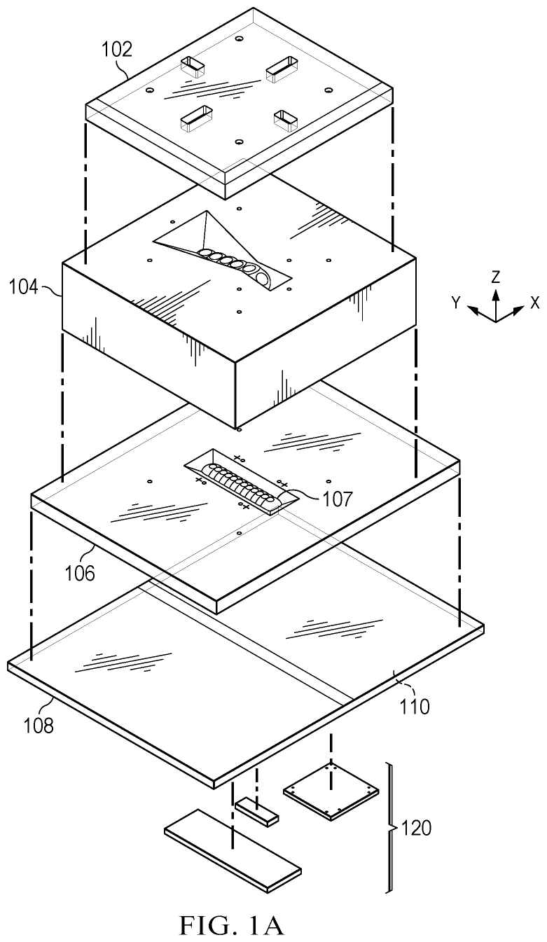

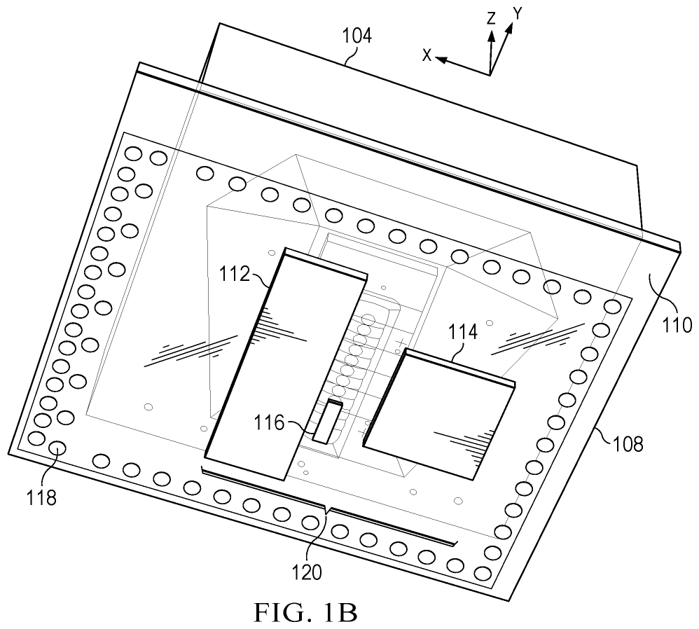

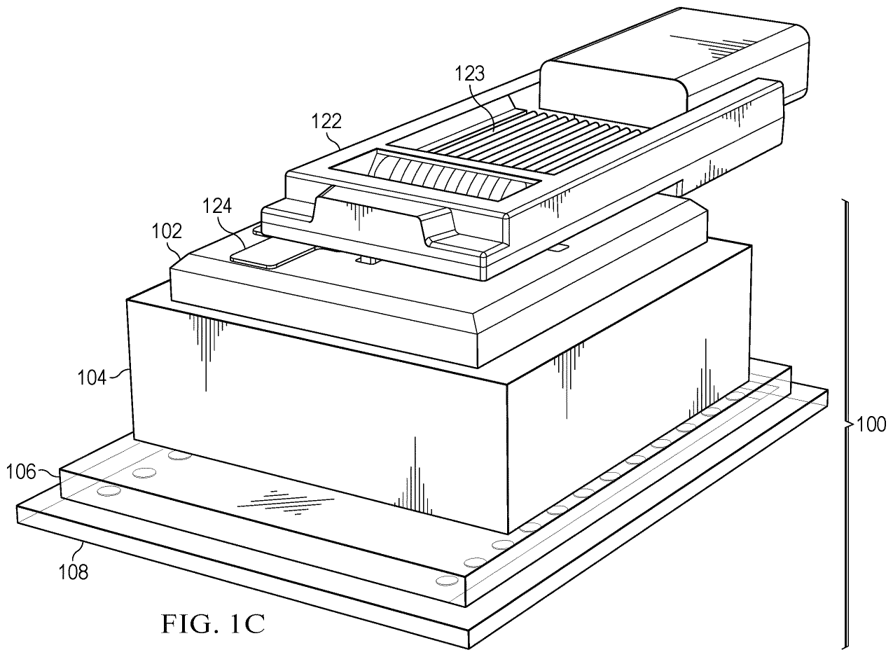

FIG. 1A shows an exploded view of a wavelength division multiplexed (WDM) interconnect module 100 according to an embodiment of the present disclosure. The WDM interconnect module may be configured for optical wavelength division multiplexing or demultiplexing for use in an optical data communication system using wavelength division multiplexing and demultiplexing, for example, in a SWDM optical communication system. The WDM interconnect module 100 may be an optical transmitter, an optical receiver, or an optical transceiver. Based on the following description, it would be clear to a person skilled in the art that the present teachings are not limited to a four-channel multiplexed configuration according to the SWDM standard, rather, such teachings may enable any multichannel multiplexed/demultiplex configuration based on a similar construction. The WDM interconnect module 100 depicted in FIGS. 1A-6 is configured as an optical transmitter but may be configured as an optical receiver or as part of an optical transceiver as described below.

The WDM interconnect module 100 of FIG. 1A may include a transparent carrier 108 having various electrical and electro-optic components 120 mounted to a bottom surface 110 of the transparent carrier 108. Situated above and mounted to a top surface of the transparent carrier 108 may be a lens array 106. Situated above and mounted to a top surface of the lens array 106 may be a multiplexing/demultiplexing (MUX/DEMUX) subassembly 104. Situated above and mounted to a top surface of the MUX/DEMUX subassembly 104 may be a connector guide 102. If used in a transmitter, the MUX/DEMUX subassembly 104 is configured to combine a plurality of optical beams having different wavelengths along a common path that propagates out from the connector guide 102. In this case, the MUX/DEMUX subassembly 104 may be considered as a multiplexing subassembly. If used in a receiver, the MUX/DEMUX subassembly 104 is configured to split a single incoming optical beam from the connector guide 102 into a plurality of optical beams having different wavelengths along different optical paths. In this case the MUX/DEMUX subassembly 104 may be considered as a demultiplexing subassembly. Each of the transparent carrier 108, the lens array 106, the MUX/DEMUX subassembly 104, and the connector guide 102 may be considered as a transmissive optical element.

The connector guide 102 may be configured to mate with an optical connector (not shown in FIG. 1A, see FIG. 1C) that terminates one or more optical fibers. Terms such as “atop”, “bottom”, “top”, “above”, “below”, “upper”, and “lower” are relative terms based on the z-axis depicted in FIG. 1A pointing in an upward or vertical direction. The WDM interconnect module 100 may be used in any orientation.

As shown in FIG. 1B, according to an embodiment of the present disclosure, the transparent carrier 108 may include a bottom surface 110 facing outwardly (i.e., direction −z) having a metallization to enable electrical connections to electronic and/or electro-optic components 120 of the WDM interconnect module 100. At least some of these components 120 may be flip-chip mounted to the bottom surface 110 of the transparent carrier 108. In a completed WDM interconnect module 100 these electronic and/or electro-optic components 120 may be covered by an encapsulant to isolate them from the surrounding environment. These components may include, but are not limited to, a light source driver 112, a module controller 114, and a light emitter assembly 116. The light source driver 112 may be mounted in proximity to the light emitter assembly 116 to minimize the length of an electrical connection between these components, which helps to improve signal integrity. According to an exemplary embodiment of the present disclosure, the light source driver 112 and module controller 114, which may be an application specific integrated circuit (ASIC), may include support for at least four channel transmission. A transparent underfill material (not visible in FIG. 1B) may be situated in a space between a top surface of the light emitter assembly 116 and the bottom surface 110 of the transparent carrier 108. The transparent underfill may enhance the reliability of the electrical connections between electrical contact pads on the transparent carrier 108 and the light emitter assembly 116. The transparent underfill material may be closely matched to a refractive index of the transparent carrier 108, reducing a Fresnel reflection as light propagates from the light emitter assembly 116 into the transparent carrier 108. An underfill material may also be used between the module controller 114 and light source driver 112 and the transparent carrier 108. The underfill material adjacent these elements may be different than that used with the light emitter assembly 116, since this underfill material need not be transparent beneath these components. The light emitter assembly 116 may comprise a plurality of individual light emitters, each light emitter emitting light at a different wavelength, arranged adjacent to each other.

With continued reference to FIG. 1A, the light emitter assembly 116 may have a plurality of emitting apertures, which are each configured to emit an optical signal at a different wavelength (i.e., a plurality of transmit optical signals). The light emitter assembly 116 may be an array of discrete VCSELs arranged in a row. Optionally the light emitter assembly 116 may include a photodetector to enable the WDM interconnect module 100 to have OTDR capability as described in more detail below. Each of the VCSELs may emit light at a different wavelength, such as, for example, at a wavelength for SWDM functionality. An array of electrical contacts 118 may be located around a perimeter of the bottom surface 110 of the transparent carrier 108. The electrical contacts 118 may be an array of copper pillars, solder balls, or some other electrical connection means. The electrical contacts 118 are configured to allow routing of electrical signals to/from electrical and electro-optic components 120 from/to a main or host circuit board (not shown in FIG. 1B). It is noted that not the entirety of the bottom surface 110 of the transparent carrier 108 may include metallization. Specifically, an area of the bottom surface 110 adjacent optical regions of the light emitter assembly 116 or a photodetector may be devoid of metallization so that optical signals may freely propagating through these areas of the bottom surface 110. Both the light emitter assembly 116 and the photodetector may be considered electro-optic elements, since they transform a light signal into an electrical signal or vice versa. It may be said that the electrical and electro-optic components 120 may be mounted on the bottom, outward facing, or metallized surface 110 of the transparent carrier 108.

Other components not shown in FIG. 1B may be included on the bottom surface 110 of the transparent carrier 108, including, for example, components to enable OTDR functionality via an OTDR controller integrated into the light source driver 112 or a standalone OTDR controller. When OTDR functionality is present, a corresponding light detector may be mounted to the bottom surface 110. For example, to support OTDR functionality in a transmitter a light detector or equivalently a photodetector may be arranged next to, or within, the light emitter assembly 116. More details on such arrangements are described below.

With reference to FIGS. 1A-1B, a lens array 106 may be arranged atop of the transparent carrier 108, and in contact (e.g., bonded) with a top surface of the transparent carrier 108 that is oppositely arranged with respect to the bottom surface 110. The top surface is not metallized in an area where light propagates through the transparent carrier 108 but may be metallized in other areas. As described in more detail below, the lens array 106 may include a transmit lens assembly 107 that is aligned with the light emitter assembly 116. The transmit lens assembly 107 may include a plurality of collimating lenses and optionally a focusing lens. The transmit lens assembly 107 may be located on a top surface of the lens array 106 as shown in FIG. 1A or may be located on the bottom surface of the lens array 106. Alignment of the lens array 106 with respect to the light emitter assembly 116 may be such to align optical axes of each of the light emitters (e.g., VCSELs) with a respective lens. For example, an optical axis of a light emitter of the light emitter assembly 116 in the direction z may be aligned (e.g., collinear) with an optical axis of a transmit lens of the lens array 106 in the direction z. Likewise an optical axis of a light detector of a light detector assembly (similar to the light emitter assembly 116) in the direction z may be aligned with an optical axis of the receive lens of the lens array 106 in the direction z. When OTDR functionality is present, a corresponding receive lens may be added to the lens array 106. For example, to support OTDR functionality in a transmitter a receive lens may be arranged next to, or within, the lens array 106.

According to an embodiment of the present disclosure, the lens array 106 (e.g., shown in FIG. 1A) may be a transparent substrate within which the lenses used for either data communication and/or OTDR functionality are formed. Such forming of the lenses may be according to known in the art techniques and processes, including for example, hot molding and etching. Alternatively, lenses may be formed by deposition of a polymer or glass on a planar surface of the lens array 106. It should be noted that although the formed lenses may have different (optical) properties in view of different wavelengths used, more practical implementations, including for support of SWDM and/or OTDR wherein wavelengths are contained within a narrow spectrum, may include formed lenses with the same optical properties. In other words, according to some exemplary embodiments, all lenses included in the lens array 106 may be collimating or focusing lenses with the same optical properties.

According to an exemplary embodiment of the present disclosure, the transparent carrier 108 and the lens array 106 may be formed within a single or common transparent substrate, including a top surface within which lens assemblies are formed and a bottom surface that may be metallized. According to a further embodiment of the present disclosure, the single transparent substrate may be used for monolithic integration of the electronic and/or electro-optic components 120. A person skilled in the art would know of fabrication techniques and processes adapted for such monolithic integration using transparent substrates, such as, for example, sapphire or glass substrates.

FIG. 1C shows a perspective view of the WDM interconnect module 100 of FIG. 1A in an assembled state with an optical connector 122 mated with the WDM interconnect module 100. The optical connector 122 may terminate one or more optical fibers 123. A sealing gasket 124 may be situated between the optical connector 122 and connector guide 102 and serves to seal an optical interface between the optical connector 122 and connector guide 102 from environmental contamination. All flat interfaces in the WMD interconnect module 100 between optically transmissive elements, such as between the transparent carrier 108 and lens array 106 and the connector guide 102 and optical connector 122 may be sealed and have some index matching material between them to reduce reflections at these interfaces. Exposed transmissive surfaces in the optical beam path may be anti-reflection coated to reduce reflection. Regions of the optical beam path outside of a transmissive element may be sealed from an outside environment to avoid external contamination of the optical path. The mated WDM interconnect module 100 depicted in FIG. 1C may be considered as an optical communication node, which may be linked in optical communication to other optical communication nodes within an optical communication system or network.

With further reference to FIG. 1C, the optical connector 122 may be removable and may be mated and unmated from the interconnect module 100 multiple times. The optical connector 122 may be a RVCON™ (Rugged Vertical CONnector) optical connector manufactured by Ultra Communications of Vista, California. The optical connector 122 terminates an optical cable containing one or more optical fibers 123 that provide a propagation path for optical signals to or from the WDM interconnect module 100. Other types of optical connectors may be used, such as but not limited to known in the art LC and/or MT style connectors. The optical connector 122 may provide a separable interface to the WDM interconnect module 100 that can be repeatedly mated and unmated. Alternatively, the optical fiber may be permanently attached to the WDM interconnect module 100 according to a so-called fiber pigtail configuration. It should be appreciated that not all the optical fibers present in the optical connector 122 need make an optical connection to the WDM interconnect module 100. In some embodiments, the optical connector 122 may have only a single optical fiber 123 that is in optical communication with the WDM interconnect module 100.

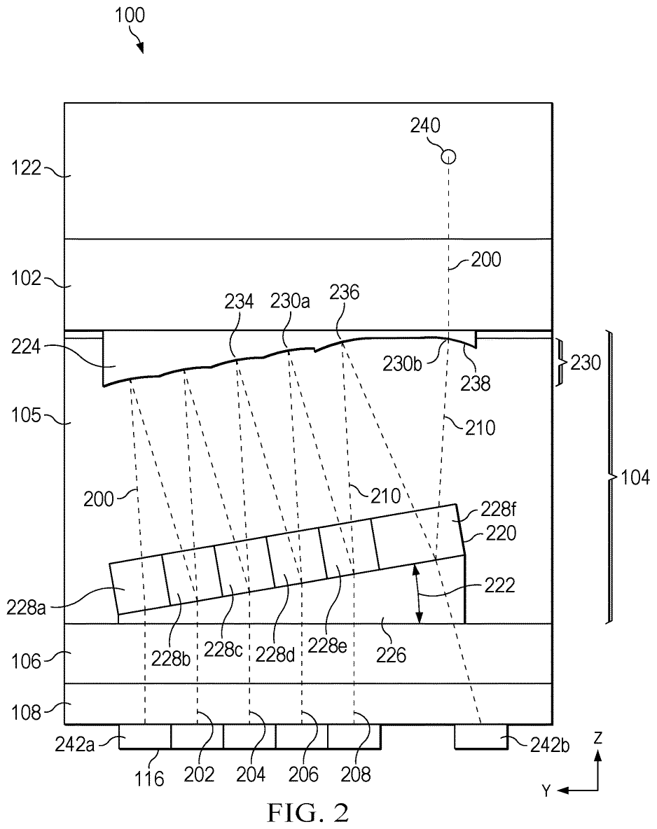

FIG. 2 shows an example layout of an optical beam path 200 through the MUX/DEMUX subassembly 104 according to an embodiment of the present disclosure. The optical beam path 200 within the WDM interconnect module 100 may be sealed from the outside environment to avoid external contamination of the optical beam path 200. The optical beam path 200 may be a transmit channel path for an optical transmitter or a receiver channel path for an optical receiver. The optical beam path 200 through the MUX/DEMUX subassembly 104 may generally be described as a zig-zag path since the optical beam path 200 bounces back and forth in the MUX/DEMUX subassembly 104. The zig-zag optical path may define a plane that lies in the (y, z) plane. The MUX/DEMUX subassembly 104 may comprise a multiplexing/demultiplexing (MUX/DEMUX) block 105 and a filter array 220.

The MUX/DEMUX subassembly 104 of FIG. 2 is configured for multiplexing a plurality of optical beams 202, 204, 206 and 208 into a common or multiplexed optical beam 210, each of the plurality of optical beams 202, 204, 206, and 208 being at a different wavelength. The first optical beam 202 may have a first wavelength, the second optical beam 204 may have a second wavelength, the third optical beam 206 may have a third wavelength, and the fourth optical beam 208 may have a fourth wavelength. The first, second, third and fourth wavelengths may be different from one another. Each of the optical beams 202, 204, 206, and 208 may be emitted by an aperture of a respective light source and propagate in a direction parallel or substantially parallel to a vertical or z-direction.

As shown in FIG. 2, after emission, the optical beams 202, 204, 206, and 208 propagate first through the transparent carrier 108, then the lens array 106, and then into the MUX/DEMUX subassembly 104. The MUX/DEMUX block 105 may be shaped as a rectangular parallelepiped having an upper recessed region 224 and a lower recessed region 226. Although not shown in FIG. 2, the upper recessed region 224 may have multiple noncontiguous sub-regions; for example, there may be two separate upper recessed regions: one above 230 and one above 230b in FIG. 2. Situated within the lower recessed region 226 of the MUX/DEMUX block 105 may be the filter array 220. The filter array 220 may be shaped as a rectangular parallelepiped oriented at an oblique angle 222 to a lateral or y-direction. The oblique angle 222 may be in a range between 5° to 15°. For example, the oblique angle 222 may be 10°.

With continued reference to FIG. 2, the filter array 220 may comprise a plurality of filters blocks 228a-228f arranged adjacent each other to form a row of filter blocks that forms the filter array 220. At least some, and in some cases all, of the adjacent filter blocks 228a-228f may contact each other, which may help to reduce a size of the WDM interconnect module. It may be said that each filter block of the plurality of filter blocks 228a-228f may be oriented at an oblique angle relative to the bottom surface of the MUX/DEMUX block 105. In some embodiments, the orientation, and thus the oblique angle 222, is the same for all filter blocks 228a-228f. Each filter block 228a-228f may have a reflective multilayer dielectric optical coating on a surface of the filter block 228a-228. These dielectric coatings may have an optical loss of less than approximately 1%, so that almost all optical power incident on the coating is either transmitted or reflected.

The filter blocks 228a-228f of FIG. 2 may be coated to provide multichannel functionality for the MUX/DEMUX subassembly 104, including respective transmission and reflection coefficients at different operating wavelengths. The coatings may be relatively insensitive to polarization, for example, reflectivity of the coating to s- and p-polarized light may be within ±5%, 10%, 20%, or 30%, of each other. Achieving polarization insensitivity of the optical coating may be made easier by having a small angle of incidence of the optical beam path 200 on the coating, for example, less than 5°, 10° or 15°. The optical coating may be on a bottom or top surface of the filter blocks 228a-228f. In FIG. 2 the optical coating is on the bottom surface, as shown by a reflection in the optical beam path 200 off this surface. The optical coating on at least some of the filter blocks 228a-228f may be different, such that each optical coating has different transmissive and reflective properties depending on a wavelength of the light striking the optical coating. For example, filter block 228b may transmit at least a portion of the first optical beam 202. The filter block 228c may transmit at least a portion of the second optical beam 204 and reflect at least a portion of the first optical beam 202 to combine the first and second optical beams 202 and 204. The filter block 228d may transmit at least a portion of the third optical beam 206 and reflect at least a portion of the first and second optical beams 202 and 204 to combine the third optical beam 206 with the first and second optical beams 202 and 204. The filter block 228e may transmit at least a portion of the fourth optical beam 208 and reflect at least a portion of the first, second, and third optical beams 202, 204 and 206 to combine the fourth optical beam 208 with the first, second and third optical beams 202, 204 and 206. Thus, the optical beams 202, 204, 206 and 208 may be sequentially combined by the filter array 220 to form a common or multiplexed optical beam 210. The multiplexed beam 210 may experience a non-combining reflection in the filter array 220 at filter block 228f of all its constituent optical beams 202, 204, 206 and 208. That is, the reflection in filter block 228f is not wavelength selective and performs no wavelength combining or splitting function. It should be appreciated that while the filter array 220 has been described as being composed of a plurality of filter blocks, in alternative embodiments according to the present disclosure, the filter array 220 may be a unitary element (e.g., filter block, optical block) with different optical coatings over different areas of the filter array 220.

The transmissive and reflective properties of the filter blocks 228a-228f shown in FIG. 2 may be varied depending on whether the WDM interconnect module 100 is being used as a transmitter or a receiver, whether OTDR functionality is included in the transmitter or receiver, and the OTDR optical layout should OTDR functionality be present. For operation with good signal integrity, VCSELs need to operate well above threshold and thus may emit milliwatts of optical power. Propagating this level of optical power through an optical communication network may introduce problems such as inducing optical nonlinearities and saturating a receiving photodetector, both of which reduce signal integrity. Thus, in many situations it is also desirable to reduce an optical power coupled into the optical fiber from the emitters in the light emitter assembly 116. In order to accomplish this optical power reduction, the filter block optical coatings may be arranged to attenuate at least some of the emitted light in some situations. Also in many applications, especially those using multimode fiber in the optical communication network, communication bandwidth is limited by dispersion, which lowers contrast in a digital optical signal, rather than optical power and thus high optical power levels propagating in the network are not required.

As noted above, FIG. 2 shows an optical layout of an interconnect module 100 configured as an optical transmitter that includes OTDR functionality. In this exemplary embodiment, a coating on the filter block 228a may be an anti-reflection coating or no coating at all since the photodetector 242a is situated behind filter block 228a and need not be wavelength selective. Filter blocks 228b-228e are located above the emitting apertures that emit optical beams 202, 204, 206, and 208, respectively. These filter blocks may have an optical coating arranged to have approximately 50% transmission and 50% reflection in the coating's bandpass region and >95% reflection for all other wavelengths. The coating on filter block 228f also need not be wavelength selective, so that coating may be arranged to have a >95% reflection for all wavelengths within an operating range of the WDM interconnect module 100. If the photodetector 242b is present, the coating on filter block 228f may have a lower reflectivity, for example, a reflectivity in a range between 50% and 90% to allow a greater fraction of a reflected signal to reach photodetector 242b. In either case it may be said that filter block 228f has an optical coating that reflects all wavelengths within an operating range of the WDM interconnect module 100. This coating arrangement allows the interconnect module 100 to both act as a transmitter and OTDR measurement instrument.

With continued reference to FIG. 2, each of the optical beams 202, 204, 206, and 208 may be incident on a top surface 230 of the upper recessed region 224. A first portion 230a of the exposed top surface 230 may have a reflective coating that reflects all wavelengths in the multiplexed optical beam 210. A different second portion 230b of the exposed top surface 230 may have an anti-reflection coating that transmits all wavelengths in the multiplexed optical beam 210. An advantage of having the non-combining or non-wavelength selective reflection in filter block 228f of the filter array 220 is that it may allow adequate separation between the reflective portion 230a and anti-reflective portion 230b of the top surface 230 so that the different reflective properties may be readily fabricated by masking of the top surface 230 during application of the optical coatings. The non-wavelength selective reflection may be an end or first reflection from the filter array 220. That is, the non-wavelength selective reflection is not interspersed between the wavelength selection reflections and is the reflection between an input/output reflector 236 and a coupling lens 238. The first portion 230a of the top surface 230, having the reflective coating, may have a plurality of relay reflectors 234 and an input/output reflector 236.

The relay reflectors 234 of FIG. 2 may have a concave curved reflective surface integrally formed on the top surface 230 of the MUX/DEMUX block 105. All the relay reflectors 234 may be identical and may have an identical orientation, that is they all point in a common direction. The input/output reflector 236 may also have a curved concave reflective surface. The curvature of the input/output reflector 236 may be the same or different than that of the relay reflectors 234. The input/output reflector 236 may have a different orientation than the relay reflectors 234, so that the multiplexed optical beam 210 has a greater separation on the filter array 220 than the spacing between the first, second, third and fourth optical beams 202, 204, 206 and 208. This enables a space between each of the plurality of relay reflectors 234 and the input/output reflector 236 to be substantially the same within manufacturing tolerances and smaller than a space between the input/output reflector 236 and the coupling lens 238.

The relay reflectors 234 of FIG. 2 may have an orientation angle from the y-direction so as to match the orientation of the filter array 220, whereas the input/output reflector 236 may have a greater angle. For example, if the angle of the filter array and relay reflectors 234 is 10°, the angle of the input/output reflector 236 may be in a range of angles between 11° and 15°, for example 13°. The multiplexed optical beam 210 may propagate through the coupling lens 238 located in the second portion 230b of the top surface 230 having an anti-reflection coating. The multiplexed optical beam 210 may then propagate through the connector guide 102 and the optical connector 122. In the optical connector 122 the multiplexed optical beam 210 may be reflected by 90° or some other angle at reflection point 240 so that the multiplexed beam is propagating out of a (y, z) plane, for example along a transverse or x-direction. In other words, in some embodiments the multiplexed optical beam 210 propagates in a direction orthogonal to the plane of the zig-zag optical path in the optical connector 122.

As disclosed above, the WDM interconnect module 100 may also include OTDR functionality. The OTDR functionality may be added by placing a photodetector on the bottom surface of the transparent carrier 108. The photodetector may be positioned on either side of the emitting apertures of the light emitting assembly 116. Shown in FIG. 2 is a photodetector 242a adjacent first optical beam 202 in the +y direction (left side of light emitter assembly 116) and photodetector 242b adjacent the fourth optical beam 208 in the −y direction (right side of light emitter assembly 116). For photodetector 242a, the optical beam path 200 of an OTDR signal passes through filter block 228a, the lens array 106, and the transparent carrier 108 before reaching the photodetector 242a. In the alternative embodiment, the OTDR signal may reach the photodetector 242b prior to reaching any of the light emitters of the light emitter assembly 116. In this alternative embodiment, a 50%/50% transmit/receive coating may to deposited on filter block 228f over the full wavelength operating range to cover all light emitter wavelengths. In this case, filter blocks 228b-228e may have high transmission properties in the passband and high reflection in the stopband. This may make the desired filtering characteristics easier to fabricate.

In some embodiments of the present disclosure, a single coating on filter block 228f may provide sufficient VCSEL attenuation, so that light emitted by the WDM interconnect module 100 is in a power range needed for good signal integrity. This arrangement also has an advantage that the photodetector 242b may be used as a monitor of the optical output of the light emitters of the light emitting assembly 116, since some portion of the plurality of optical beams 202, 204, 206 and 208 can pass through the filter block 238f and strike the photodetector 242b. The photodetector 242b may be used to monitor the performance of an individual light emitter by only operating a single emitter while all other emitters were off. Accordingly, each emitter in the light emitter assembly 116 may be sequentially monitored to ensure proper operation and detect possible degradation in performance.

During an OTDR measurement cycle, a portion of the light emitted (e.g., light pulses, light timing pulses) at the one or more wavelengths via a corresponding light emitter from the light emitter assembly 116 may be transmitted into an optical fiber that terminates in the optical connector 122. A reflected signal from some fault or discontinuity in the optical fiber or in an optical network in optical communication with the optical fiber will return to the WDM interconnect module 100. The reflected signal may be detected in the photodetector 242a or 242b. A time delay between the emitted and detected light pulse may be used as a signal in the optical time domain reflectometer to determine a distance from the WDM interconnect module 100 to a fault or discontinuity in an optical fiber communication network.

With continued reference to FIGS. 1A-1C and 2, according to an exemplary embodiment of the present disclosure, dimensions (i.e., width W and length L) in the (x, y) plane of the interconnect module 100 may be as small as approximately 8 mm by 8 mm. Thus, a footprint of the WDM interconnect module 100 may be less than 10 mm by 10 mm. A height of the WDM interconnect module 100 along the z-direction may be less than 4 mm. Accordingly, the WDM interconnect module 100 may provide a compact package that is mechanically robust, has a sealed optical path (e.g., optical beam path 200), and is capable of operating over a wide temperature range. Since the optical path is sealed, the WDM interconnect module 100 may be operated in a dirty environment or may be immersion cooled. The WDM interconnect module 100 may be capable of surviving and operating over severe shock and vibration profiles typical of applications such as automotive, avionics or space launch vehicles. Resistance to damage from shock and vibration is enabled by various features of the WDM interconnect module 100. These features include a low mass of the WDM interconnect module 100 and its rigid construction. For example, the mass of the WDM interconnect module 100 may be less than approximately 2, 1.5, 1 or 0.8 grams. The solid MUX/DEMUX block 105 may be considered as the main structural unit of the WDM interconnect module 100. Various elements are mounted to or formed in its top and/or bottom surfaces.

To enable operation over a wide temperature range, such as between approximately −55 C to 95 C, it is important that alignment of the optical beam path 200 be maintained over the operating temperature range. To help maintain alignment, a coefficient of thermal expansion of the MUX/DEMUX block 105, the connector guide 102, the lens array 106, and the transparent carrier 108 may be matched to within ±5%, ±10% ±20% or ±50% of each other. The coefficient of thermal expansion between these elements may also be matched to that of the light emitter or light detector assembly 116 to within ±5%, ±10% +20% or ±50% of each other. The light emitter and/or detector assembly 116 may comprise a III-V semiconductor, such as GaAs or InP or it may be fabricated on a silicon die. Materials that may be appropriate for the MUX/DEMUX block 105, the connector guide 102, the lens array 106, and the transparent carrier 108 include some types of glass, such as but not limited to BK7, and sapphire. According to an embodiment of the present disclosure, the various transparent elements may also be matched in their respective index of refraction to within ±5%, ±10% or ±20% to minimize reflections at interfaces between them.

The optical connector 122 may also use a substrate or ferrule that supports the one or more optical fibers 123 having a thermal expansion coefficient matched to that of the elements in the WDM interconnect module 100 to within the tolerances described above. Alternatively, the optical connector 122 need not have matching thermal expansion coefficients, since the mechanical interface between the optical connector 122 and WDM interconnect module 100 may accommodate differential thermal expansion without damaging either component.

Temperature dependence of the reflective and transmissive properties of the optical coatings used in the filter array 220 is another important consideration in enabling operation of the WDM interconnect module 100 over a wide temperature range. An emission wavelength of a VCSEL light emitter will vary depending on the temperature of the surrounding environment. For a VCSEL operating in a wavelength range between approximately 800 nm to 1000 nm, the wavelength shift with temperature is approximately 0.07 nm/C. Over the operating temperature window of approximately −55 C to 95 C the emission wavelength of a VCSEL will thus shift by approximately 10 nm. This shift may be a significant fraction of the spacing between adjacent wavelength channels. For example, in the SWDM standard specification the channel spacing is 30 nm, so the wavelength shift is about a third of the channel spacing. Since all emitters shift by approximately the same amount with temperature, the wavelength separation between channels will not significantly change; however, if the reflective and transmissive properties of the optical coating do not substantially match those of the VCSELs, operation of the WDM interconnect module 100 may be compromised. It is thus advantageous if a wavelength shift with temperature of the passbands of the optical coating can be matched to that of the VCSELs to within ±5%, ±10% ±20% or ±50%. A matched wavelength dependence of the optical coating with temperature may be arranged by an appropriate selection of coating materials and deposition techniques.

Because of the wavelength shift with temperature of a VCSEL and VCSEL's wavelength manufacturing tolerance, in some applications it may be advantageous to employ a WDM communication system (including a WDM interconnect module 100) with larger channel spacings than the 30 nm spacing of the SWDM standard specification. For example, the channel spacing may be approximately 35 nm, 40 nm, 45 nm, or 50 nm. An exemplary WDM communication system using a 45 nm channel spacing may operate at the following nominal wavelengths: 850 nm, 895 nm, 940 nm, and 985 nm.

In addition to a wide temperature operating range, the WDM interconnect module 100 may be capable of withstanding a wide storage temperature range. For example, the WDM interconnect module 100 may be configured to withstand a storage temperature range of between approximately −55 C to +125 C. This wide temperature storage range is enabled by matching the coefficient of thermal expansion of the various elements of the WDM interconnect module 100 as described above and selecting appropriate adhesives, encapsulants, sealants, and underfill materials that are compatible with these temperatures.

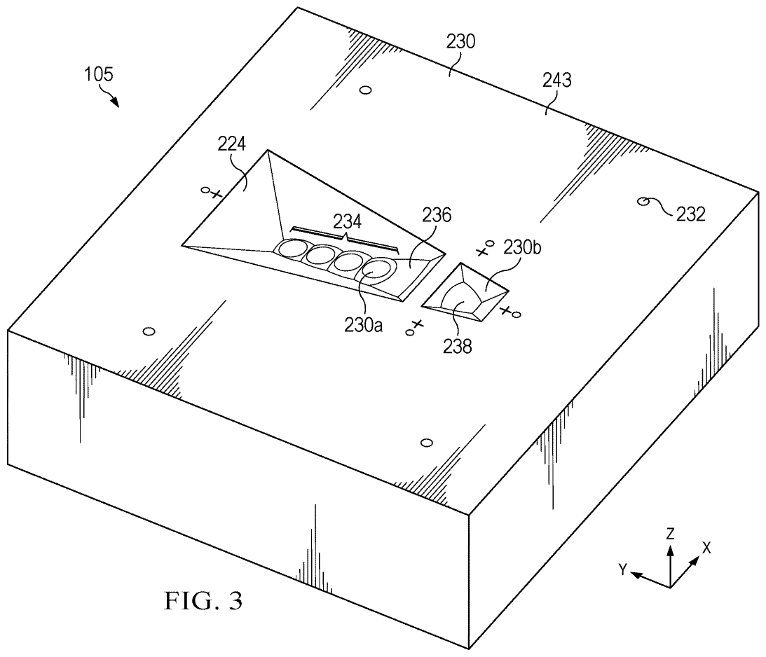

FIG. 3 shows a top perspective view of the MUX/DEMUX block 105 according to an embodiment of the present disclosure. As described earlier, the MUX/DEMUX block 105 may be generally shaped as a rectangular parallelepiped having an upper recessed region 224 in the top surface 230 of the MUX/DEMUX block 105. Said another way, the top surface 230 may have an upper recessed region 224 surrounded by a flat top surface 243. The flat top surface 243 may be configured to mate with and seal against a first mating surface of another transmissive optical element in the WDM interconnect module 100 (not shown in FIG. 3). The first mating surface may be the bottom surface of the connector guide 102 (see FIG. 1A). As described earlier, the upper recessed region 224 may be divided into two portions, a first portion 230a with a reflective coating and a second portion 230b with an anti-reflective coating. Relay reflectors 234 and an input/output reflector 236 may be located in the first portion 230a. The coupling lens 238 may be located in the second portion 230b. The top surface 230 may also have a plurality of alignment features 232 configured to register the connector guide 102 (not shown in FIG. 3, see FIG. 1A) to the top surface 230.

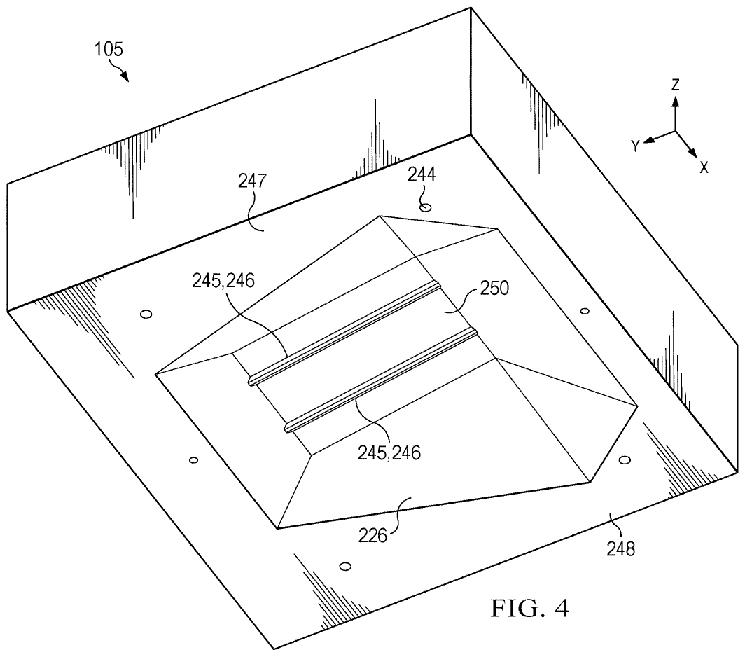

FIG. 4 shows a bottom perspective view of the MUX/DEMUX block 105 according to an embodiment of the present disclosure. A bottom surface 248 of the MUX/DEMUX block 105 may have a lower recessed region 226 surrounded by a bottom flat surface 247. The bottom flat surface 247 may be parallel or substantially parallel within manufacturing tolerances to the top flat surface 243 (not visible in FIG. 4). The bottom flat surface 247 may be configured to mate with and seal against a second mating surface of another transmissive optical element in the WDM interconnect module 100. The second mating surface may be the top surface of the lens array 106 (see FIG. 1A). A top surface 250 of the lower recessed region 226 may have an alignment feature 246 to which the filter array (220, not shown in FIG. 4) is registered against. The alignment feature 246 may be two parallel raised projections 245 that are generally oriented in the y-direction, but at an oblique angle 222 (not labeled in FIG. 4, see FIG. 2) to the bottom flat surface 247, which is parallel to the (x, y) plane. In other embodiments, bumps or pedestals may be used instead of two parallel linear raised projections. In still other embodiments, the top surface 250 of the lower recessed region 226 may be substantially flat and featureless and other mechanisms may be used to control a position and orientation of the filter blocks 228a-228f on the top surface of the lower recessed region. These mechanisms may include use of spacer beads and control of mounting parameters, such as adhesive volume, bonding pressure, planarity, and gap thickness of a flip-chip bonder that may be used to mount the filter blocks 228a-228f to the top surface 250 of the lower recessed region 226.

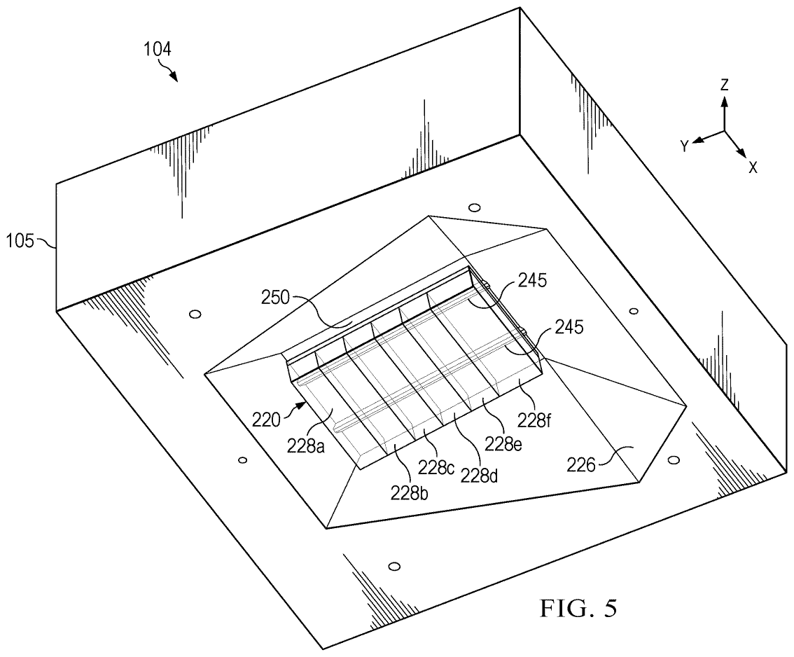

FIG. 5 shows the filter array 220 mounted to the top surface 250 of the lower recessed region 226 according to an embodiment of the present disclosure. As previously described, the filter array 220 may comprise a plurality of filter blocks 228a-228f. The individual filter blocks 228a-228f may be sequentially registered against the two parallel raised projections 245 and then secured to the top surface 250. The individual filter blocks 228a-228f may be secured to the top surface 250 of the lower recessed region 226 using an adhesive. In some embodiment, a space between filter blocks 228a-228f and the MUX/DEMUX block 105 may be partially or totally filled with an optically transparent adhesive. In this case the optical beam path 200 (see FIG. 2) may extend through the filling adhesive. In some embodiments an adhesive may be present in the space between filter blocks 228a-228f and the MUX/DEMUX block 105, the adhesive may eliminate the need for an anti-reflection coating by approximately matching the refractive index of the filter blocks 228a-228f and the MUX/DEMUX block 105. In other embodiments, the optical beam path 200 may not extend through the optically transparent adhesive. In this case, it may be advantageous to apply an anti-reflection coating to the two exposed surfaces through which the optical beam path 200 extends (a top surface of the filter blocks 228a-228f that faces the MUX/DEMUX block 105 and the top surface 250 of the lower recessed region 226). Advantageously the two parallel raised projections 245 allow precise angular orientation of the filter blocks 228a-228f since an interface area between the filter blocks 228a-228f and each parallel raised projection 245 may be a direct line contact without any adhesive between them.

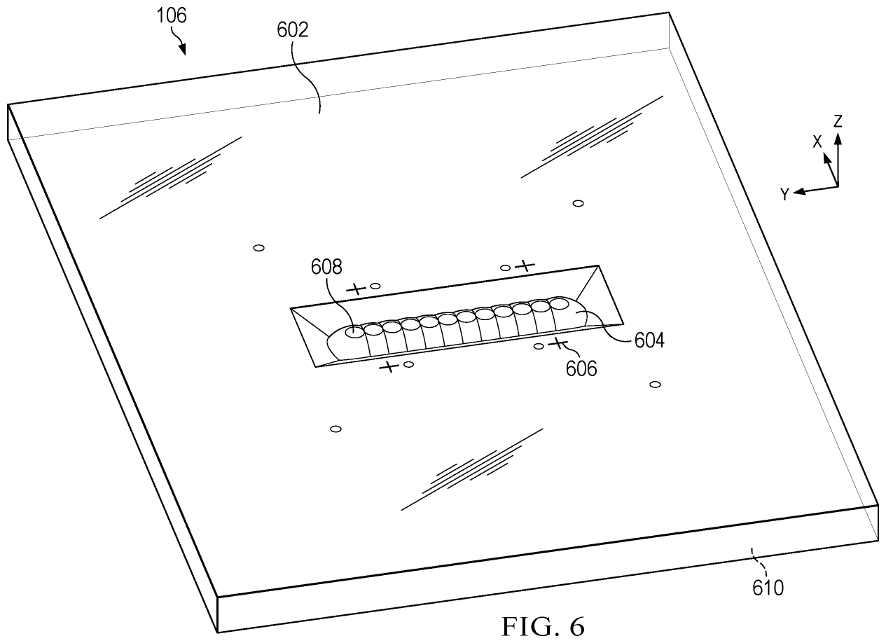

FIG. 6 shows a top perspective view of a lens array 106 according to embodiment of the present disclosure. The lens array 106 may shaped as a rectangular parallelepiped having a top surface 602 and an opposed bottom surface 610. A recessed region 604 may be situated in the top surface 602 or bottom surface 610. The recessed region 604 may be surrounded by flat portions of either one of the top surface 602 or the bottom surface 610. FIG. 6 depicts the recessed region 604 in the top surface 602.

Since the lens array 106 of FIG. 6 is being used in an optical transmitter it may be considered as a transmit lens assembly. A plurality of lenses 608 may be situated in the recessed region 604. The plurality of lenses 608 may be arranged such that no part of any such lens extends past the top surface 602 or bottom surface 610. The lenses 608 may include a collimating lens if the lens is in an optical path of an emitter, or a focusing lens if the lens is in an optical path of a photodetector. In some instances, it may be desirable to deliberately move the focal point of the lenses 608 away from the emitting aperture of the light emitter assembly 116 to minimize feedback into the light sources of the light emitter assembly. Feedback can destabilize an output of the light sources reducing contrast in the optical signal. The deliberate positioning of the focal point away from the emitting apertures of the light emitter assembly (e.g., 116 of FIG. 2) may reduce coupling efficiency into the optical fiber, but generally sufficient light will still be coupled into the optical fiber. The focal distance of the lenses 608 or the distance of the lenses between the light emitter faces can be selected to have a reduced level of feedback while still providing adequate optical coupling to the optical fiber, as would be understood by one skilled in the art. Also, on the top surface 602 of the lens array 106 may be a plurality of alignment features 606. The alignment features 606 help to register the lens array 106 against the bottom surface of the MUX/DEMUX block 105 (see FIG. 1A).

FIG. 6 shows the lens array 106 having twelve lenses whereas in FIG. 2 there are four emitting apertures and one or two photodetectors so only five or six lenses are required in the lens array. The lens array 106 thus has more lenses than required by the WDM interconnect module 100. The mismatch between the required number of lenses and the number of lenses depicted in FIG. 6 is that the lens array embodiment depicted in FIG. 6 may be used in a single wavelength, parallel channel interconnect module as well as the WDM interconnect module 100 described herein. For example, the lens array 106 may be used in a 4x-by-4x optical transceiver having four transmit and four receive channels. The pitch of the lenses 608 may be 250 microns, which matches the fiber spacing in an MT fiber ferrule. Advantageously, using the same lens array 106 across multiple interconnect module platforms may allow the interconnect platforms to be produced at lower cost.

The WDM interconnect module 100 depicted in FIGS. 1A-1C and 2-6 has generally been described as an optical transmitter; however, the same basic arrangement may be used as an optical receiver with minor modifications. In an optical receiver, the light emitter assembly 116 may be replaced by a light detector assembly consisting of an array of photodetectors. The light detector assembly may include a plurality of light detectors arranged in a row, each of the light detectors detecting light at a different wavelength, such as, for example, at a wavelength for SWDM functionality. The light detector assembly may comprise a plurality of individual light detectors arranged in a row or a monolithic die having a plurality of light detectors. The wavelength selectivity is provided by the different optical coatings in the filter array 220, which pass only a certain wavelength range of light to the various photodetectors. That is, at least some of the optical coatings in the filter array 220 are wavelength selective. The optical coatings transmit wavelengths over a passband and reflected wavelengths outside of the passband. The optical receiver may support at least four channel reception. The array of photodetectors may be monolithic or may comprise discrete photodetectors each on an individual die. To enable OTDR functionality and/or bidirectional communication capability, the photodetector 242a or 242b may be replaced by a light emitter, such as a VCSEL. The highly reflective coating on the first portion 230a of the upper recessed region 224 may be the same for a receiver as for a transmitter. The filter array 220 may be different in a receiver than a transmitter. The filter array 220 may be arranged to have a high transmission, such as >95%, at the wavelength of the passed optical beam, and a high reflection, such as >95% reflection, at the wavelength of the non-passed optical beams. The photodetectors in the light detector assembly are in optical alignment with at least some of the lenses 208 in the lens array 106. The light detector assembly thus includes a plurality of receive focusing lenses and optionally a collimating lens to support OTDR functionality. The collimating lens would be in optical alignment with a light source, such as a VCSEL, that replaces the photodetectors 242a or 242b in a transmitter.

An optical transceiver with wavelength division multiplexing/demultiplexing capability may be formed by integrating the functionality of the previously disclosed optical transmitter and receiver into a single package. This may be achieved using several approaches. In a first approach, an optical transmitter and optical receiver similar to those depicted and in FIGS. 1A-1C and 2-6 and described in the preceding text may simply be packaged adjacent each other in a common housing. All the components such as the transparent carrier, lens array, MUX/DEMUX subassembly, connector guide, and optical connector would need to be duplicated. A second approach would be to enlarge the transparent carrier so it would accommodate two MUX/DEMUX subassemblies and the components that mate to these subassemblies. All the electrical and electro-optic components required for transceiver operation may be placed on a bottom surface of the common transparent carrier. A third approach would be to have a single optical connector having both transmit and receive optical fibers. The MUX/DEMUX subassembly may then have two optical paths, one for a transmit channel and one for a receive channel. The transmit and receive channels may be displaced or offset from each other in the transverse or x-direction. The lens array may have two rows of lenses, one for transmit channels and one for receive channels. A single connector guide and optical connector may be used. For example, a single RVCON™ connector or MT style connector may be used having a transmit fiber for transmitted optical signals and a receive fiber for received optical signals.

Embodiments with OTDR functionality incorporated into the WDM interconnect module 100 having a single optical fiber coupled to the WDM interconnect module 100 may have bidirectional communication capability. In a WDM interconnect module 100 primarily configured as an optical transmitter, the photodetector 242a or 242b shown in FIG. 2 may serve to receive optical signals propagating into the WDM interconnect module 100. Thus, it may be said that the photodetector 242a or 242b may have a dual functionality of both being part of an OTDR system and being a receiver in an asymmetric bidirectional communication system. The bandwidth of the communication system may be asymmetric with wavelength division multiplexed optical signals produced by the optical transmitter having a higher bandwidth than the optical signals received by the photodetector 242a or 242b. In an embodiment where the WDM interconnect module 100 is primarily an optical receiver, the photodetector 242a or 242b may be replaced by a light emitter. In this case, the bandwidth of the communication system may be asymmetric with wavelength division multiplexed optical signals detected by the optical receiver having a higher bandwidth than the optical signals transmitted by the light emitter.

The invention has generally been described as using a VCSEL based light emitter assembly mounted on the bottom surface of the transparent carrier, but the invention is not so limited. Edge emitting laser diodes may be used in the light emitter assembly 116 instead of VCSELs. Alternatively, the light source may be a photonic integrated circuit (PIC) that utilizes a mirror or surface grating coupler to couple light between the PIC and the lens array 106 (see FIG. 2). Surface grating couplers generally emit and/or receive light at an oblique angle of incidence to a coupling aperture of the surface grating coupler. As such, the arrangement of the optical beam path 200 will change to accommodate the oblique angle of incidence emission.

The invention has been described as having an operating temperature range of approximately −55 C to 95 C; however other operating temperature ranges are possible. For example, the operating temperature range may be approximately −40 C to 95 C or −45 C to 95 C. Likewise the storage temperature range may be different than −55 C to 125 C.

While the invention has generally been described as transmitting and/or receiving a single wavelength division multiplexed signal, the invention is not so limited. In order to increase a data communication bandwidth of a wavelength division multiplexed interconnect module parallel optical channels may be used. For example, there may be two wavelength division multiplexed transmit optical channels and/or two wavelength division multiplexed receive optical channels. Parallel optical channels may be obtained by replicating the zig-zag optical path 200 depicted in FIG. 2 and displacing the replicated zig-zag path in the transverse or x-direction from the original path. Both zig-zag paths may use the same filter blocks, which are now extended in the transverse direction so that they extend over both parallel optical paths. The lens array may be modified to provide lenses for all optical paths. The number and arrangement of the emitters and detectors in the emitter/detector light assemblies may be correspondingly adjusted. For example, instead of four emitters arranged in a single row in a single channel module eight emitters arranged in two parallel rows of four emitters each displaced from each other in the transverse direction may be used in a two-channel module. Similarly, instead of four photodetectors arranged in a single row in a single channel module eight photodetectors arranged in two parallel rows of four photodetectors each displaced from each other in the transverse direction may be used in a two-channel module. If more than two channels are needed to support higher bandwidth operation, the module may include additional parallel channels, such as but not limited to four or eight parallel channels.

In other embodiments of the invention, an electrically conductive through via may connect the bottom surface of the transparent carrier with the top surface of the transparent carrier substrate. Use of an electrically conductive via allows electrical components to be mounted on the top surface as well as the bottom surface of the transparent carrier substrate.

While the invention as generally been described as transmitting and/or receiving a single wavelength division multiplexed signal, the invention is not so limited. In order to increase a data communication bandwidth of a wavelength division multiplexed interconnect module, parallel optical channels may be used. For example, there may be two wavelength division multiplexed transmit fibers and/or two wavelength division multiplexed receive fibers. Parallel multiplexed optical channels may be obtained by replicating the zig-zag optical path 200 depicted in FIG. 2 and displacing the replicated zig-zag path in the transverse or x-direction from the original path. Both zig-zag paths may use the same filter blocks, which are now extended in the transverse direction so that they extend over both parallel multiplexed optical paths. The lens array may be modified to provide lenses for all optical paths. The number and arrangement of the emitters and detectors in the emitter/detector light assemblies may be correspondingly adjusted. For example, instead of four emitters arranged in a single row in a single channel module, eight emitters arranged in two parallel rows of four emitters each displaced from each other in the transverse direction may be used in a two-channel module. Similarly, instead of four photodetectors arranged in a single row in a single channel module, eight photodetectors arranged in two parallel rows of four photodetectors each displaced from each other in the transverse direction may be used in a two-channel module. If more than two parallel multiplexed channels are needed to support higher bandwidth operation, the module may include additional parallel multiplexed transmit or receive channels, such as, but not limited to four or eight channels.

It will be understood that many additional changes in the details, materials, steps and arrangement of parts, which have been herein described and illustrated to explain the nature of the invention, may be made by those skilled in the art within the principle and scope of the invention as expressed in the appended claims. For example, the invention may be used with a long wavelength WDM system, such as wavelengths between 1200 nm and 1600 nm. The invention has generally been described as using multimode optical fiber, but in some embodiments single mode optical fiber may be used. A signal mode light source, such as a PIC or single mode VCSEL, may be coupled into either a single mode or a multimode optical fiber by the WDM interconnect module. Use of a multimode optical fiber will result in more relaxed mechanical tolerances improving manufacturability. In yet another embodiment, one or more of the various transmissive optical elements, such as the MUX/DEMUX block, the transparent carrier, the lens array, and the lens guide may comprise an optically transparent polymer, rather than glass or an inorganic crystal. An advantage of this embodiment may be lower cost; however, such an embodiment will likely not work over an extended temperature range.

It is understood that the specific order or hierarchy of steps in the processes disclosed is an example of applicable approaches. Based upon design preferences, the specific order or hierarchy of steps in the processes may be rearranged while remaining within the scope of the present disclosure. The accompanying method claims present elements of the various steps in a sample order and are not meant to be limited to the specific order or hierarchy presented.

1-133. (canceled)

134. A wavelength division multiplexed interconnect module for optical data communication comprising:
a multiplexing/demultiplexing subassembly comprising
a multiplexing/demultiplexing block having a top surface and an opposed bottom surface, the top surface having an upper recessed region surrounded by a top flat surface and the bottom surface having a lower recessed region surrounded by a bottom flat surface; and
a filter array situated in the lower recessed region and mounted to a top surface of the lower recessed region; and
a light emitter assembly or a light detector assembly.

135. The wavelength division multiplexed interconnect module as recited in claim 134, wherein the top flat surface and the bottom flat surface are substantially parallel to each other.

136. The wavelength division multiplexed interconnect module as recited in claim 134, wherein the top flat surface is configured to seal against a first mating surface.

137. The wavelength division multiplexed interconnect module as recited in claim 136, wherein the bottom flat surface is configured to seal against a second mating surface.

138. The wavelength division multiplexed interconnect module as recited in claim 137, wherein the top flat surface includes alignment features that help to register the top flat surface to the first mating surface and the bottom flat surface includes alignment features that help to register the bottom flat surface to the second mating surface.

139. The wavelength division multiplexed interconnect module as recited in claim 134, wherein the multiplexing/demultiplexing block is shaped as a rectangular parallelepiped.

140. The wavelength division multiplexed interconnect module as recited in claim 134, wherein wavelength division multiplexed interconnect module may be configured as an optical transmitter, an optical receiver, or an optical transceiver.

141. The wavelength division multiplexed interconnect module as recited in claim 134, further comprising a connector guide, a lens array, and a transparent carrier.

142. The wavelength division multiplexed interconnect module as recited in claim 141, wherein a coefficient of thermal expansion of the multiplexing/demultiplexing block, the connector guide, the lens array, and the transparent carrier are matched within ±50% of each other.

143. The wavelength division multiplexed interconnect module as recited in claim 142, wherein matching of the coefficient of thermal expansion of the multiplexing/demultiplexing block, the connector guide, the lens array, and the transparent carrier helps allow the wavelength division multiplexed module to operate over a temperature range of approximately −55 C to +95 C.

144. The wavelength division multiplexed interconnect module as recited in claim 134, wherein the filter array comprises a plurality of filter blocks arranged in a row and each filter block of the plurality of filter blocks contact an adjacent filter block.

145. The wavelength division multiplexed interconnect module as recited in claim 134, wherein a plurality of relay reflectors, an input/output reflector, and a coupling lens are situated in the upper recessed region of the multiplexing/demultiplexing block and the plurality of relay reflectors, the input/output reflector, and the coupling lens are integrally formed on the top surface of the multiplexing/demultiplexing block.

146. The wavelength division multiplexed interconnect module as recited in claim 134, wherein an optical path of a transmit or receive channel in the wavelength division multiplexed interconnect module is sealed from an outside environment.

147. The wavelength division multiplexed interconnect module as recited in claim 141, further comprising an electro-optic element, wherein the electro-optic element is flip-chip mounted on a bottom surface of the transparent carrier.

148. The wavelength division multiplexed interconnect module as recited in claim 134, wherein the wavelength division multiplexed interconnect module has optical time domain reflectometer functionality.

149. The wavelength division multiplexed interconnect module as recited in claim 134, wherein a mass of the wavelength division multiplexed interconnect module is less than approximately 1 gram.

150. A method of forming a multiplexing/demultiplexing subassembly comprising;
molding a multiplexing/demultiplexing block, wherein the multiplexing/demultiplexing block has an upper recessed region and a lower recessed region; and
mounting a filter array to the multiplexing/demultiplexing block in the lower recessed region.

151. The method of forming the multiplexing/demultiplexing subassembly as recited in claim 150, wherein the lower recessed region has an alignment feature to enable accurate registration of the filter array.

152. The method of forming the multiplexing/demultiplexing subassembly as recited in claim 151, wherein the alignment feature is two parallel linear raised projections on a top surface of the lower recessed region.

153. The method of forming the multiplexing/demultiplexing subassembly as recited in claim 151, wherein each of the plurality of filter blocks is in direct contact with the alignment feature.

154. The method of forming a multiplexing/demultiplexing subassembly as recited in claim 150, wherein the upper recessed region includes a plurality of relay reflectors, an input/output reflector, and a coupling lens formed on a top surface of the upper recessed region.
